(19) United States
(12) Patent Application Publication
(10) Pub. No.: US 2011/0188056 A1
(43) Pub. Date: Aug. 4, 2011

(54) MEASURING APPARATUS AND MEASURING METHOD

(75) Inventor: Hiroyuki Muto, Kawasaki-shi (JP)

(73) Assignee: CANON KABUSHIKI KAISHA, Tokyo (JP)

(21) Appl. No.: 13/005,745

(22) Filed: Jan. 13, 2011

(30) Foreign Application Priority Data
Feb. 2, 2010 (JP) 2010-021586

(51) Int. Cl. G01B 11/28

(52) U.S. Cl. 356/630

(57) ABSTRACT

A plurality of positions of a toner image formed on the image carrier of an image forming apparatus are irradiated with light. A plurality of light-receiving elements of a light-receiving unit receive a plurality of reflected lights reflected at the plurality of positions of the toner image. The light-receiving position of the light-receiving unit corresponding to each of the plurality of received reflected lights is detected. The toner height at each of the plurality of positions of the toner image is determined based on the detected light-receiving position.

### BACKGROUND OF THE INVENTION

1. Field of the Invention

The present invention relates to a technique of measuring the amount of toner applied to the image carrier of an image forming apparatus using the electrophotographic method.

2. Description of the Related Art

The colors of an image formed by an image forming apparatus using the electrophotographic method may change due to variations in various parameters. In particular, the development and transfer processes greatly contribute to variations in colors, and there are environmental variations such as variations in temperature and humidity, and variations in the latent image potential, toner supply amount, transfer efficiency, and the like. For this reason, the amount of toner applied to the photosensitive drum and the transfer belt does not stabilize even when predetermined device settings are used in image formation.

The toner adhesion amount on the photosensitive drum or the transfer belt is measured to maintain stable development and transfer processes. Based on the measurement result, the exposure amount, development voltage, transfer current, and the like are fed back for control, thereby suppressing variations in colors.

A conventional toner adhesion amount measuring method irradiates a toner image with light and detects the amount or position of the reflected light. For example, a method disclosed in Japanese Patent Laid-Open No. 8-327331 or 4-156479 detects the reflected light amount obtained when irradiating the image carrier (the background of a toner patch) with light and the reflected light amount obtained when irradiating the toner patch with light, and measures the toner adhesion amount based on the change in the reflected light amount. Image density parameters are controlled based on the measured amounts.

Note that for the toner adhesion amount measurement based on the reflected light amount, there is known a technique of changing the optical arrangement of the light-receiving element depending on the color of toner to be measured. At the time of black toner (K) measurement, light emitted by the light source is reflected by the carrier (background) and the toner patch. The light-receiving element installed at the specular reflection position detects the change in the amount of specularly reflected light, thereby measuring the toner adhesion amount. On the other hand, at the time of color toner (CMY) measurement, the light-receiving element receives light diffused by the carrier (background) and the toner patch and detects the change in the amount of diffused light, thereby measuring the toner adhesion amount.

Japanese Patent Laid-Open No. 2007-199591 discloses a method of detecting the toner adhesion amount by measuring the thickness (layer thickness) of a toner patch using a laser displacement gauge. Spot light irradiates the image carrier, and reflected light forms an image at a position corresponding to the thickness of a toner patch applied to the carrier. A PSD (Position Sensing Device) detects the change in the image formation position to measure the toner adhesion amount. Feedback control of the image density parameters of the image forming system is performed based on the measurement result.

Note that measuring the toner adhesion amount based on the reflection position allows adhesion amount measurement independently of the toner color because it measures the physical shape of the toner patch.

The present inventor has proposed a method of irradiating a toner patch with a laser beam, measuring the toner adhesion amount based on the information of both the amount and position of reflected light, and calculating the toner adhesion amount while assigning a weight to measurement data in a measurement region where the pieces of information are accurately obtained.

In the conventional toner adhesion amount measurement, when the toner patch layer thickness on the transfer belt in the image forming apparatus is measured, a toner patch layer thickness profile including random noise is obtained, as shown in FIG. 1. The random noise is generated by unevenness of the toner surface shape and the transfer belt surface shape or unevenness of reflected light in the laser spot, and serves as the main factor of poor accuracy of toner layer thickness measurement.

To reduce the random noise and raise the measurement accuracy, averaging is effective. For averaging, it is necessary to measure a plurality of identical patches as many as possible in the image forming apparatus. FIG. 2 shows the relationship between the average distance and the standard error of sensor output in toner adhesion amount measurement on the transfer belt. That is, FIG. 2 shows the relationship between averaging and the measurement accuracy. As is apparent from FIG. 2, averaging needs to be performed as many times as possible to obtain a higher measurement accuracy.

However, to obtain the measurement accuracy necessary for practical use, a lot of identical patches need to be formed. This increases the toner consumption and measurement time.

In addition, not only the random noise but also undulation for a long period caused by decentering or fluttering of the rollers of the transfer belt or photosensitive drum also serves as a large factor of poor measurement accuracy.

### SUMMARY OF THE INVENTION

The present invention provides a toner height sensor capable of simultaneously measuring a plurality of measurement points in toner adhesion amount measurement.

According to an aspect of the present invention, there is provided a measuring apparatus for measuring a toner height of a toner image formed on an image carrier of an image forming apparatus, comprising: an irradiation unit configured to irradiate a plurality of positions of the toner image with light; a light-receiving unit having a plurality of light-receiving elements and configured to receive a plurality of reflected lights reflected at the plurality of positions of the toner image; and a determination unit configured to detect a light-receiving position of the light-receiving unit corresponding to each of the plurality of reflected lights received by the plurality of light-receiving elements and determine the toner height at each of the plurality of positions of the toner image based on the detected light-receiving position.

According to another aspect of the present invention, there is provided a measuring method of a measuring apparatus for measuring a toner height of a toner image formed on an image carrier of an image forming apparatus, comprising: irradiating a plurality of positions of the toner image with light; causing a light-receiving unit having a plurality of light-receiving elements to receive a plurality of reflected lights reflected at the plurality of positions of the toner image; and detecting a light-receiving position of the light-receiving unit corresponding to each of the plurality of reflected lights received by the plurality of light-receiving elements and determining the toner height at each of the plurality of positions of the toner image based on the detected light-receiving position.

Further features of the present invention will become apparent from the following description of exemplary embodiments (with reference to the attached drawings).

### BRIEF DESCRIPTION OF THE DRAWINGS

FIG. 1 is a graph showing the toner layer thickness profile including random noise;

FIG. 2 is a graph showing the relationship between the average distance and the standard error of sensor output in toner adhesion amount measurement on a transfer belt;

FIG. 3 is a view showing an example of the arrangement of the printer engine of an image forming apparatus using the electrophotographic method;

FIG. 4 is a control block diagram showing the process of the printer engine based on a toner adhesion amount;

FIG. 5 is a view showing toner patches formed on the transfer belt;

FIG. 6 is a view showing an example of the arrangement of a toner adhesion amount measuring apparatus according to the embodiment;

FIG. 7 is a view for explaining toner adhesion amount measurement on the transfer belt;

FIG. 8 is a view showing details of the light irradiation unit of the toner adhesion amount measuring apparatus;

FIG. 9 is a flowchart illustrating toner adhesion amount calculation processing of a calculation unit 606;

FIG. 10 is a graph showing region division of waveform data;

FIG. 11 is a view for explaining calculation of a toner height and a toner reflected light amount;

FIG. 12 is a view showing toner adhesion amount measurement on the transfer belt according to a modification;

FIG. 13 is a flowchart illustrating toner adhesion amount calculation processing according to the modification; and

FIG. 14 is a view showing an example of background correction according to the modification.

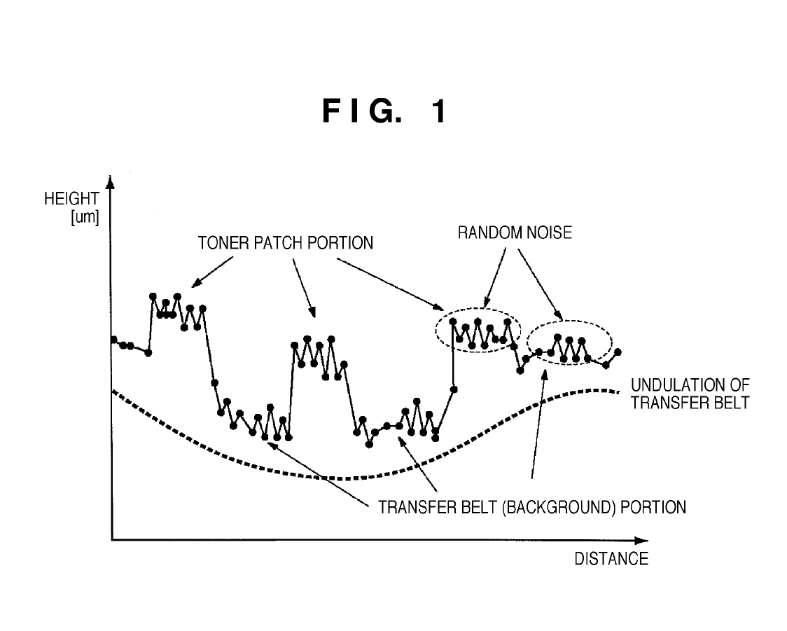

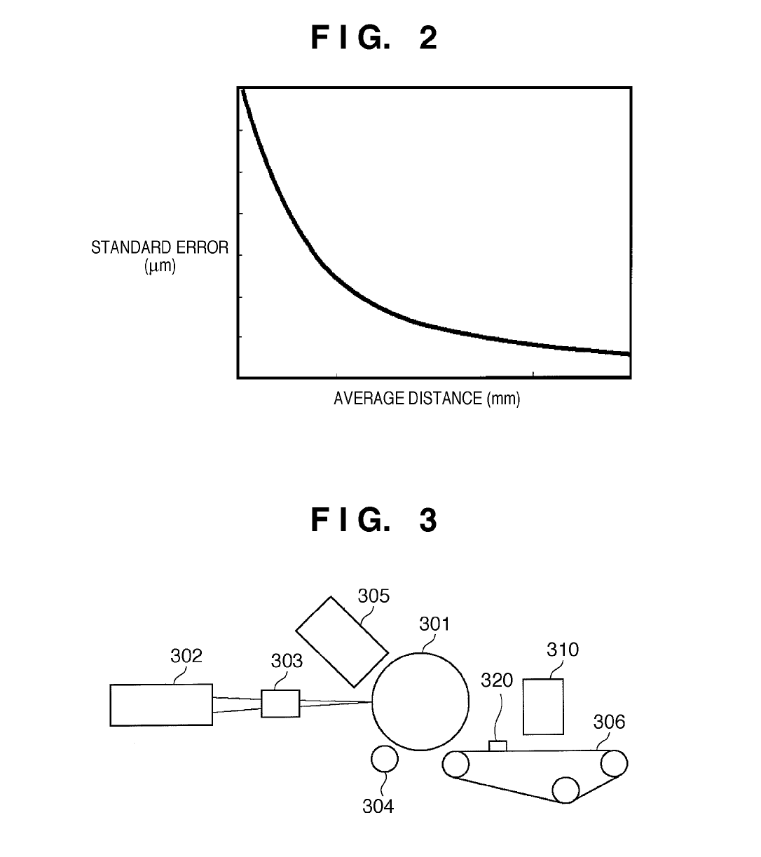

### DESCRIPTION OF THE EMBODIMENTS

The mode for carrying out the present invention will now be described in detail with reference to the accompanying drawings. In this embodiment, a measuring apparatus will be described, which measures the toner adhesion amount of a toner image formed on the image carrier of an image forming apparatus using the electrophotographic method.

[Toner Patch Measurement in Printer Engine]

FIG. 3 is a view showing an example of the arrangement of the printer engine of the image forming apparatus using the electrophotographic method. As shown in FIG. 3, the printer engine includes a photosensitive drum 301, exposure laser 302, polygon mirror 303, charge roller 304, developer 305, transfer belt 306 serving as an image carrier, and toner adhesion amount measuring apparatus 310. Note that in the image forming apparatus shown in FIG. 3, only constituent elements that appear in the following description are illustrated, and the remaining constituent elements are omitted.

First, the charge roller 304 charges the surface of the photosensitive drum 301, and the exposure laser 302 and the polygon mirror 303 expose the surface of the photosensitive drum 301, thereby creating an electrostatic latent image. Then, the developer 305 develops a toner patch 320 on the surface of the photosensitive drum 301. After transferring the toner patch from the photosensitive drum 301 to the transfer belt 306, the installed toner adhesion amount measuring apparatus 310 measures the toner adhesion amount of the toner patch 320 on the transfer belt 306. Note that the toner adhesion amount measurement is not limited to this, and for example, may be performed on the surface of the photosensitive drum 301 after the developer 305 has developed the toner patch on the photosensitive drum 301.

[Feedback Control Using Toner Application Amount Measuring Apparatus]

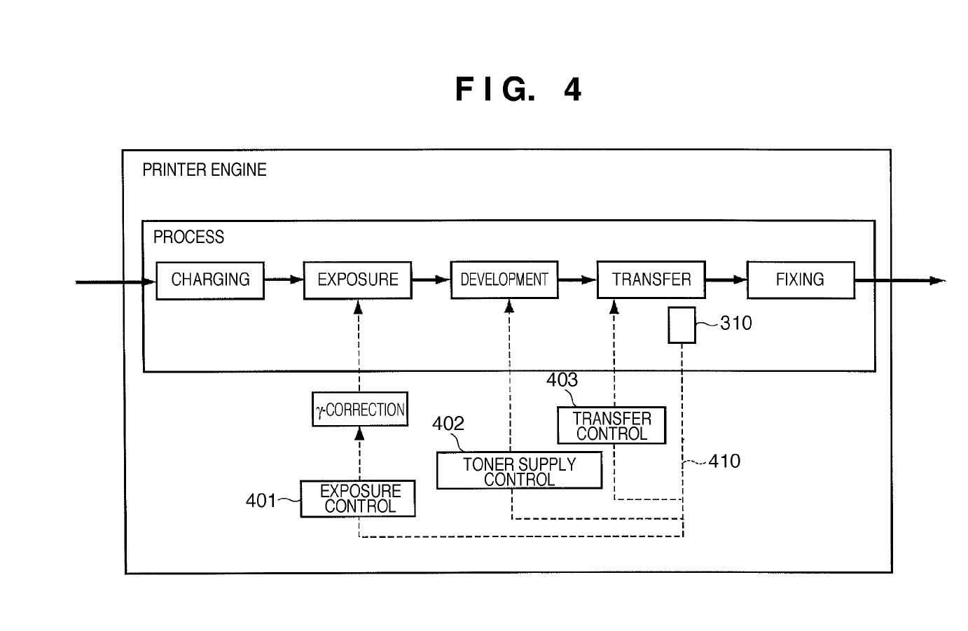

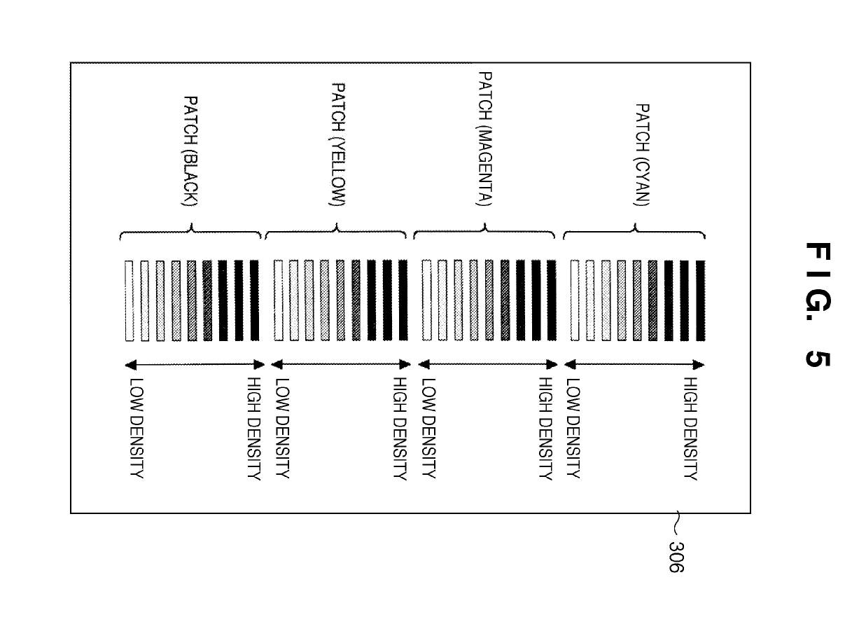

FIG. 4 is a control block diagram showing the process of the printer engine controlled based on adhesion amount data measured by the toner adhesion amount measuring apparatus. Note that FIG. 4 illustrates only constituent elements that appear in the following description, and the remaining constituent elements are omitted.

First, the toner adhesion amount measuring apparatus 310 measures the adhesion amount of the toner patch 320 applied to the transfer belt 306 after transfer (toner amount sensing), and feeds back measured toner adhesion amount data 410 to each control. In this example, the data is fed back to exposure control 401, toner supply control 402, and transfer control 403. Note that toner patches to be measured include, for example, cyan (C), magenta (M), yellow (Y), and black (K) toner images having low to high densities, as shown in FIG. 5.

Next, the exposure control 401, toner supply control 402, and transfer control 403 for the process are performed based on the toner adhesion amount data 410 that is fed back. More specifically, the exposure control 401 is executed by correcting the γ characteristic of the toner density.

The toner adhesion amount is measured, and feedback control is done based on the measurement result in the above-described way. This makes it possible to suppress the instability of the process and contribute to color stabilization.

[Arrangement of Toner Application Amount Measuring Apparatus]

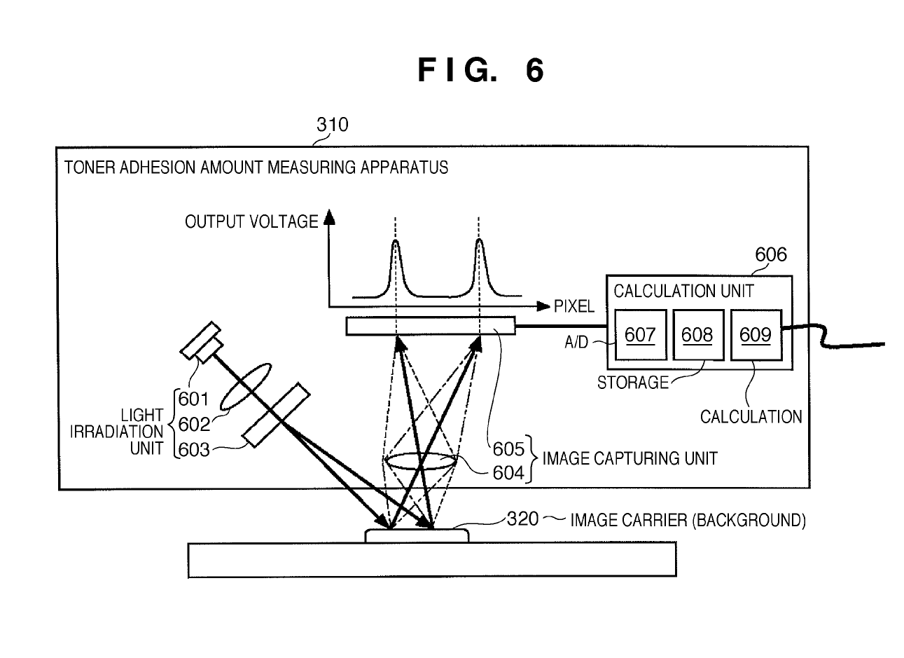

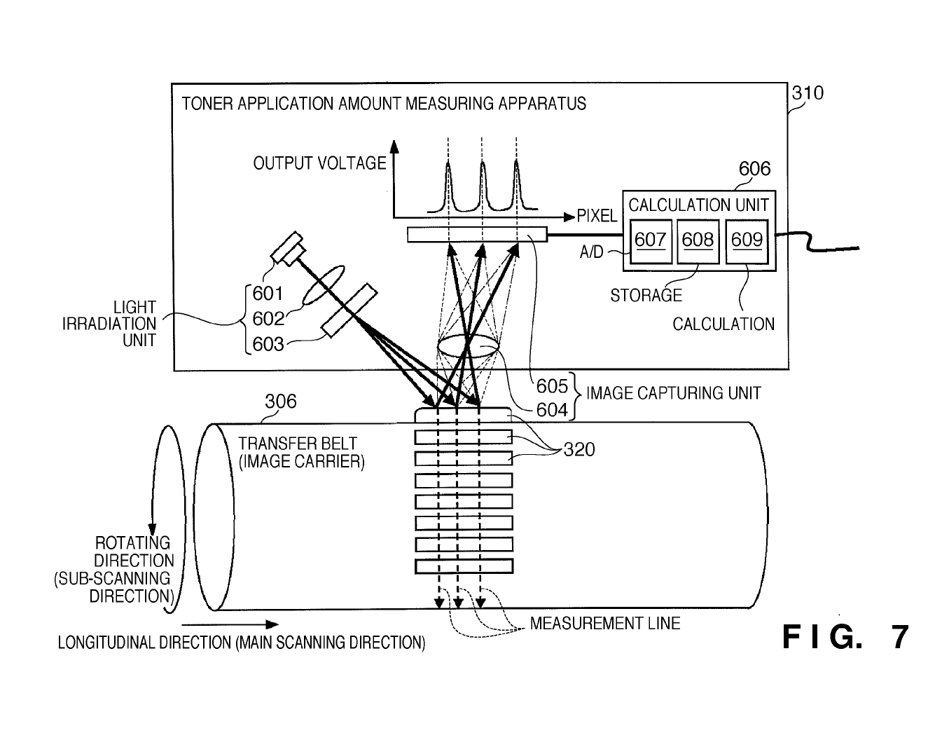

FIG. 6 is a view showing an example of the arrangement of the toner adhesion amount measuring apparatus according to the embodiment. The toner adhesion amount measuring apparatus 310 includes a light irradiation unit formed from a laser source 601, condenser lens 602, and diffraction grating 603, an image capturing unit formed from a light-receiving lens 604 and a CMOS line sensor 605, and a calculation unit 606. The calculation unit 606 includes an A/D conversion unit 607, storage unit 608, and toner amount calculation unit 609.

The laser source 601 irradiates the carrier (background) and the toner patch 320 with light. The condenser lens 602 condenses the laser beam into a small spot. The diffraction grating 603 splits the laser beam having passed through the condenser lens 602 into a plurality of beams. The light-receiving lens 604 forms, on the CMOS line sensor 605, the images of the plurality of light beams reflected by the toner patch 320. The CMOS line sensor 605 captures the image of the reflection waveform of the light image formed by the light-receiving lens 604. The calculation unit 606 calculates the toner adhesion amount based on the line sensor signal waveform output from the CMOS line sensor 605. Note that splitting the laser beam into a plurality of beams may be done using not the diffraction grating 603 but a beam splitter or the like.

[Toner Application Amount Measurement Procedure]

The procedure of measuring the toner adhesion amount will be described. When measuring the toner adhesion amount, a plurality of laser beams first irradiate a surface portion of the carrier (background) where no toner patch 320 is formed. The CMOS line sensor 605 detects diffused light from the carrier to obtain a diffused reflection waveform. Next, the laser irradiation position moves to the position of the toner patch 320. The CMOS line sensor 605 detects the diffused reflection waveform from the toner patch 320. All the plurality of laser irradiation positions are located on the toner patch 320.

The toner adhesion amount is calculated by performing signal processing (to be described later) for the reflection waveform data thus obtained from the carrier (reference) and the toner patch (change amount) and calculating the change amount of the detected data. Note that the data change amount includes the reflection waveform peak position change amount and the reflection waveform area change amount.

[Toner Application Amount Measurement: Light Irradiation Unit]

The operation of each unit in toner adhesion amount measurement will be described next in detail. FIG. 7 is a view for explaining toner adhesion amount measurement on the transfer belt in the printer engine. First, light from the laser source 601 passes through the condenser lens 602 and enters the diffraction grating 603. The light that has entered the diffraction grating 603 causes the diffraction phenomenon and splits into a plurality of beams due to mutual interference. The plurality of split light beams irradiate the measurement sample at a predetermined interval.

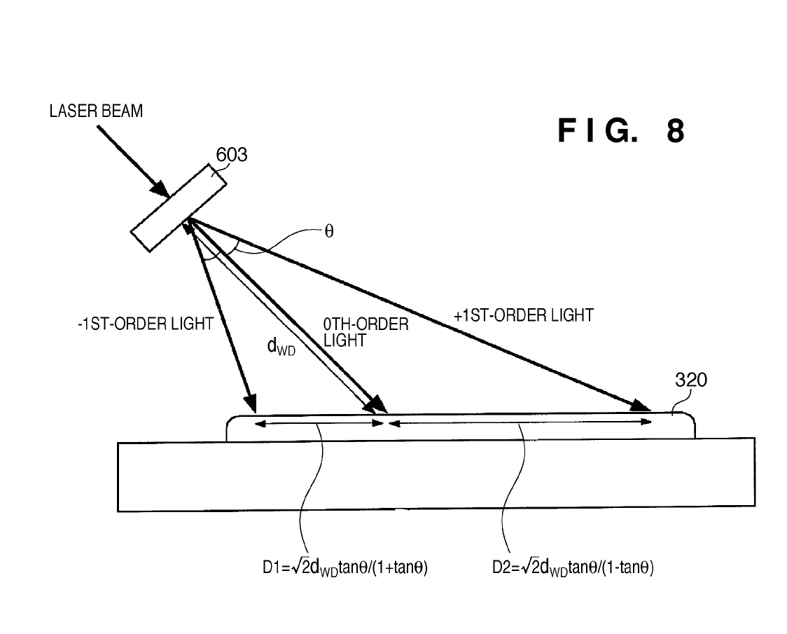

In the following description, the laser beam splits into three beams. FIG. 8 is a view showing details of the light irradiation unit of the toner adhesion amount measuring apparatus. The light that has passed through the diffraction grating 603 is divided into three light components, that is, 0th-order light, +1st-order light, and −1st-order light, and the three light beams irradiate the measurement sample. The angle of incidence of the 0th-order light is assumed to be 45°. Based on the relationship between a diffraction angle θ and a diffraction grating position dWD, laser spot intervals D1 and D2 on the measurement sample are given by

D1=√2dWD tan θ/(1+tan θ) (1)

D2=√2dWD tan θ/(1−tan θ) (2)

When θ is small, and tan θ<<1 can hold, D1 and D2 can also be obtained by

D1≈D2≈√2dWD tan θ (3)

Note that to obtain desired laser spot intervals, the diffraction angle and diffraction grating position are determined using the above equations, and the shape, pitch, and the like of the diffraction grating 603 are determined.

The irradiation positions of the split laser beams on the measurement sample are arranged in the rotating direction (that is, sub-scanning direction) and vertical direction (longitudinal direction, that is, main scanning direction) of the transfer belt, as shown in FIG. 7. In this embodiment, all the three light beams irradiate the toner patch 320. Note that the irradiation positions may be arranged obliquely with respect to the rotating direction of the transfer belt 306.

In this embodiment, as the transfer belt 306 rotates, the toner patches 320 and the transfer belt 306 are alternately scanned at all the three measurement positions.

[Toner Application Amount Measurement: Light-Receiving Unit]

Next, the three light beams diffused by the measurement sample pass through the light-receiving lens 604 and form images on one line sensor 605. The light-receiving lens 604 and the line sensor 605 are arranged at positions within the solid angle where only diffused light is received, that is, at positions where no specularly reflected light is included. The line sensor 605 converts each image of light into an electrical signal and sends it to the calculation unit 606.

The waveform on the line sensor 605 has a distribution pattern as shown in FIG. 7. The distribution pattern is obtained by compositing the diffused reflection waveforms of the three split light beams and has three peaks. The calculation unit 606 (to be described later) calculates toner height information and toner reflected light amount information at each measurement point from the data of each peak, averages the obtained data, and then calculates the toner amount.

In this embodiment, toner height information and toner reflected light amount information are calculated at each measurement point. Instead, toner height information at each measurement point may be calculated as the toner amount.

[Toner Application Amount Measurement: Calculation Unit]

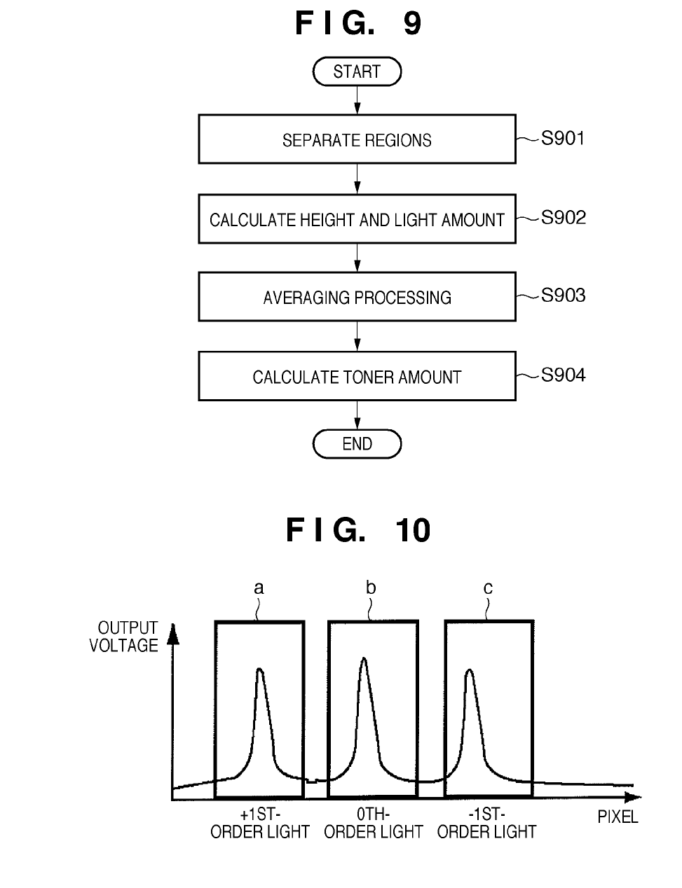

FIG. 9 is a flowchart illustrating toner adhesion amount calculation processing of the calculation unit 606. The calculation unit 606 includes the A/D conversion unit 607, storage unit 608, and toner amount calculation unit 609. The A/D conversion unit 607 converts an analog signal output from the line sensor 605 into a digital signal. The toner amount calculation unit 609 performs an operation for the waveform data converted by the A/D conversion unit 607 into a digital signal, thereby calculating the toner amount. The storage unit 608 stores the waveform data converted into the digital signal and the calculation result of the toner amount calculation unit 609.

The toner amount calculation unit 609 is implemented by software processing by a microcomputer or the like or hardware processing by a user logic. Note that the processing of the calculation unit 606 may be performed by a printer controller or a controller connected to the printer engine.

Toner adhesion amount calculation processing to be executed by the toner amount calculation unit 609 will be explained. In step S901, region division is performed for waveform data converted by the A/D conversion unit 607 into a digital signal so as to set the region of each peak.

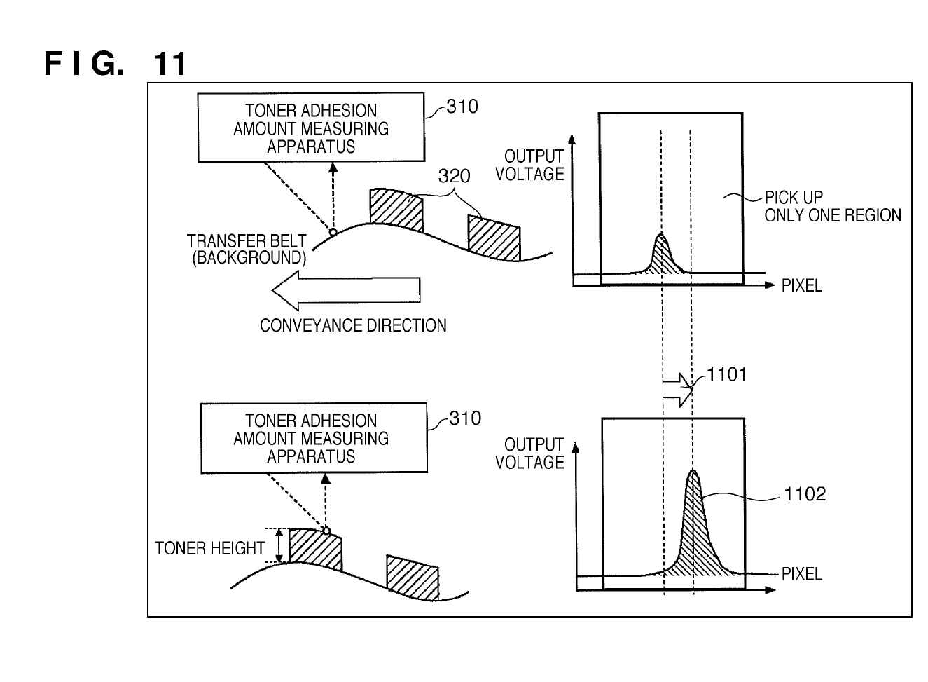

In the example shown in FIG. 10, the region of reflected light from the +1st-order light is defined as a region a, the region of reflected light from the 0th-order light is defined as a region b, and the region of reflected light from the −1st-order light is defined as a region c, thereby dividing the waveform data into three regions. Each region includes a peak and its peripheral region. The regions need to be set such that adjacent light beams do not interfere with each other. Note that if a region without influence of adjacent light is determined in advance from the viewpoint of optical design, the region is stored in the calculation unit.

In step S902, toner height information and toner reflected light amount information at each measurement point are calculated from reflected light waveform data in each set region. This processing is performed in each region, and the same processing is performed for each region.

FIG. 11 is a view for explaining calculation of the toner height and toner reflected light amount. In the toner amount calculation, a peak position representing the highest intensity of diffused reflection waveform data in each pixel region is detected to calculate the reflection position, thereby calculating a reflection position change amount 1101 between the carrier and the toner patch. The obtained reflection position change amount is defined as the toner height.

In the toner reflected light amount calculation, the area of the peak portion of diffused reflection waveform data in each pixel region is calculated, thereby calculating an area change amount 1102 between the carrier (background) and the toner patch. The obtained change amount of the diffused light amount is defined as the toner reflected light amount.

Note that to detect a peak position from reflection waveform data, for example, a method is usable which performs curve fitting by the least square method using a Gaussian function, thereby performing a predictive operation based on the parameters of the Gaussian function after the approximation. The Gaussian function has a bell-shaped peak at x=μ, as represented by

$$f ( x ) = \frac{A}{\sqrt{2 {πσ}^{2}}} exp \{ - \frac{{( x - μ )}^{2}}{2 {σ}^{2}} \} + C \qquad ( 4 )$$

where μ is the peak position, and A is the increase/decrease in the peak height or width.

Equation (4) is approximated to reflection waveform data in each pixel region, thereby calculating a feature amount representing the shape of the reflection waveform as the parameter value of the equation. The peak position μ of the obtained parameter can be used as the reflection position (a feature point of the distribution pattern) of light reflected by the sample.

Note that, for example, a Lorentz function (equation (5)) or a quadratic function (equation (6)) may be used for the approximation in place of the Gaussian function. Alternatively, instead of performing the approximation, the maximum value or the centroid of waveform may be detected as the reflection position.

$$\begin{matrix}f ( x ) = \frac{2 A}{π} \cdot \frac{w}{4 {( x - B )}^{2} + {w}^{2}} + C & ( 5 ) \\ f ( x ) = {A ( x - B )}^{2} + C & ( 6 )\end{matrix}$$

In this way, the toner height information and the toner reflected light amount information at the irradiation positions of the three split light beams are obtained.

In step S903, averaging is performed for each of the toner height information ad the toner reflected light amount information at the three measurement points to calculate the representative value of the toner height and that of the toner reflected light amount. Note that the averaging processing may be performed for only height data that readily contains random noise.

In step S5904, the toner adhesion amount is calculated based on the obtained toner height representative value and toner reflected light amount representative value. More specifically, the toner adhesion amount is calculated while assigning a weight to measurement data in a measurement density region where the height representative value and the light amount representative value are accurately obtained. Note that the toner height representative value may directly be obtained as the toner adhesion amount.

[Toner Application Amount Measurement: Toner Amount Feedback]

The toner adhesion amount measuring apparatus 310 feeds back the toner adhesion amount obtained in the above-described steps to exposure control, toner supply control, and transfer control.

[Modification]

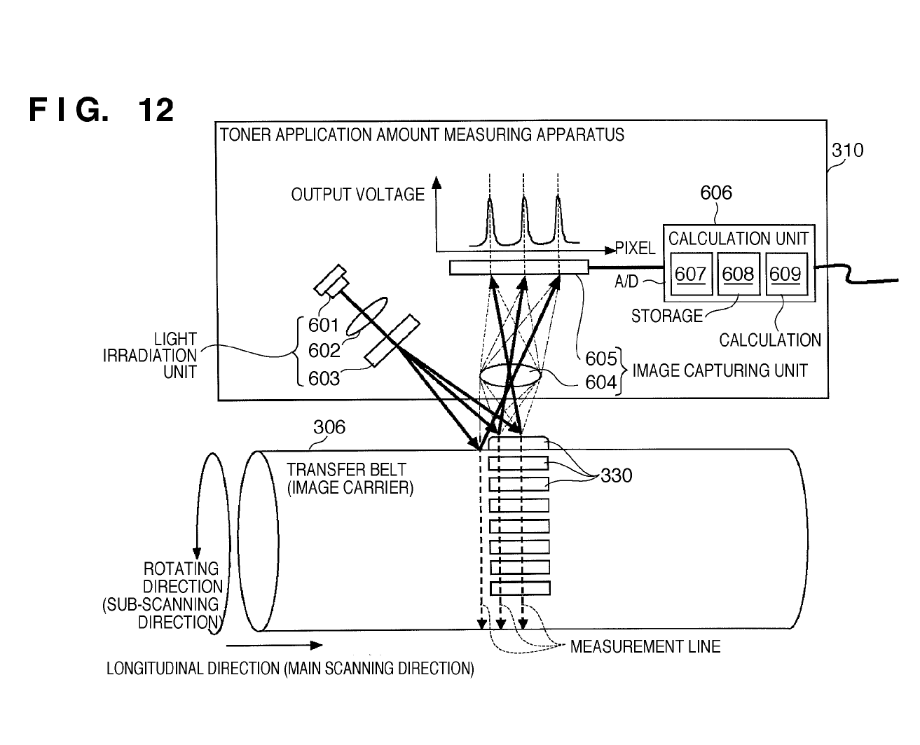

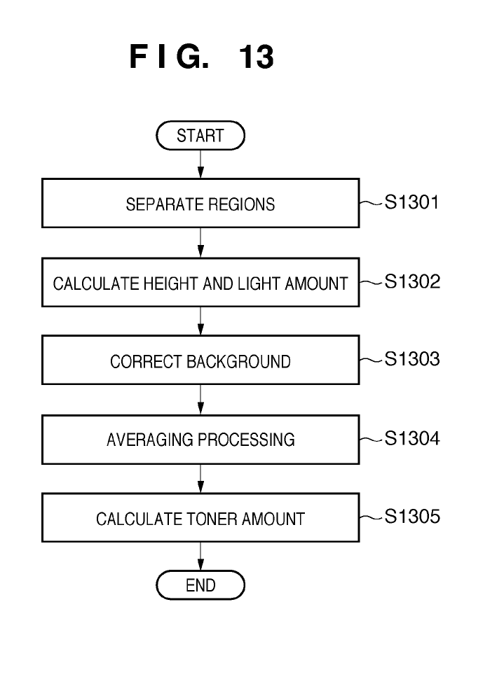

A modification of the embodiment of the present invention will be described next with reference to the accompanying drawings. FIG. 12 is a view showing toner adhesion amount measurement on the transfer belt according to the modification. In the embodiment, three split light beams irradiate the toner patch, and three measurement points are measured simultaneously. In the modification, two of the three split light beams irradiate a toner patch 330, and one light beam irradiates the transfer belt so as to measure the transfer belt (background) together with the toner patch 330. Subtracting the measurement result on the transfer belt (background) from that on the toner patch allows to cancel the influence of undulation of the background.

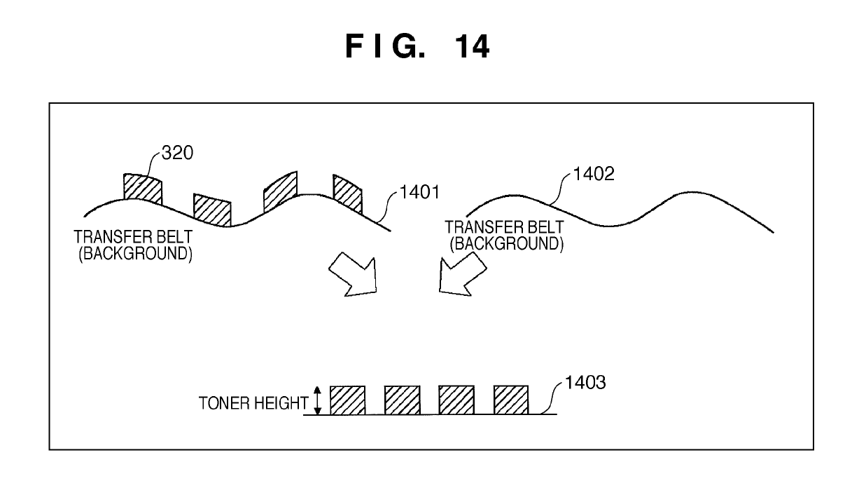

FIG. 13 is a flowchart illustrating toner adhesion amount calculation processing according to the modification. Note that steps S1301 to S1305 of the modification are the same as steps S901 to S904 shown in FIG. 9 except that background correction processing (S1303) by the calculation unit 606 is inserted because the irradiation positions are different, and a description thereof will not be repeated.

In step S1303, background height information at the measurement point (one point) of the transfer belt is subtracted from obtained toner height information at the measurement points (two points) of the patch 330, thereby performing background correction. FIG. 14 is a view showing an example of background correction according to the modification. As indicated by 1401 in FIG. 14, a height profile obtained by measuring the toner patches has large undulation on which the toner patches 320 exist. As indicated by 1402 in FIG. 14, a height profile obtained by measuring the transfer belt has only large undulation. In the background correction processing, the height profile of the transfer belt (background) is subtracted from that of the toner patches, thereby calculating only a toner height profile without the undulation component, as indicated by 1403 in FIG. 14.

In this embodiment, an optical element such as a diffraction grating splits light from one light source, thereby enabling simultaneous measurement at a plurality of positions. However, providing a light source capable of irradiating a plurality of positions allows measurement at a plurality of measurement points. Hence, the arrangement may include a plurality of light sources or use a multi-beam laser source.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-021586, filed Feb. 2, 2010, which is hereby incorporated by reference herein in its entirety.

What is claimed is:

1. A measuring apparatus for measuring a toner height of a toner image formed on an image carrier of an image forming apparatus, comprising:
an irradiation unit configured to irradiate a plurality of positions of the toner image with light;
a light-receiving unit having a plurality of light-receiving elements and configured to receive a plurality of reflected lights reflected at the plurality of positions of the toner image; and
a determination unit configured to detect a light-receiving position of said light-receiving unit corresponding to each of the plurality of reflected lights received by the plurality of light-receiving elements and determine the toner height at each of the plurality of positions of the toner image based on the detected light-receiving position.

2. The apparatus according to claim 1, wherein the reflected lights received by said light-receiving unit are reflected lights reflected at the plurality of positions of the toner image by diffused reflection.

3. The apparatus according to claim 1, wherein said light-receiving unit comprises a line sensor, and a line that connects the plurality of positions of the toner image is parallel to a line that connects the plurality of light-receiving elements of the line sensor.

4. The apparatus according to claim 1, further comprising a representative value acquisition unit configured to acquire a height representative value at the plurality of positions based on the toner heights at the plurality of positions of the toner image determined by said determination unit.

5. A measuring method of a measuring apparatus for measuring a toner height of a toner image formed on an image carrier of an image forming apparatus, comprising:
irradiating a plurality of positions of the toner image with light;
causing a light-receiving unit having a plurality of light-receiving elements to receive a plurality of reflected lights reflected at the plurality of positions of the toner image; and
detecting a light-receiving position of the light-receiving unit corresponding to each of the plurality of reflected lights received by the plurality of light-receiving elements and determining the toner height at each of the plurality of positions of the toner image based on the detected light-receiving position.

6. A computer-readable storage medium storing a program which causes a computer to execute a measuring method of a measuring apparatus of claim 5.
